(19) United States
(12) Patent Application Publication
(10) Pub. No.: US 2026/0307717 A1
(43) Pub. Date: Oct. 8, 2026

(54) POSITION DETECTION DEVICE

(71) Applicant: Proterial, Ltd., Tokyo (JP)

(72) Inventors: Yohei SHIRAKAWA, Tokyo (JP); Yoshiaki YANAGISAWA, Tokyo (JP); Yukio IKEDA, Tokyo (JP)

(73) Assignee: Proterial, Ltd., Tokyo (JP)

(21) Appl. No.: 19/636,113

(22) Filed: Apr. 1, 2026

(30) Foreign Application Priority Data
Apr. 7, 2025 (JP) 2025-063368
Dec. 22, 2025 (JP) 2025-274660

(51) Int. Cl. B62D 15/02; B62D 5/04; G01B 7/00; G01D 5/20

(52) U.S. Cl. CPC B62D 15/02; B62D 5/0421; B62D 5/046; G01B 7/003; G01D 5/2066

(57) ABSTRACT

A position detection device is provided for detecting an axial position of a shaft movable relative to a fixed member within a predetermined range. The device includes a detection coil fixed to the fixed member, a detection body fixed to the shaft, and an excitation coil configured to generate magnetic flux linking the detection coil and the detection body. The detection coil includes first and second portions extending parallel to each other in the axial direction and a connecting portion therebetween, the first and second portions being arranged at least partially in a direction perpendicular to their extending direction. The detection body includes a first detection body portion facing the first portion in a first region of the moving range and a second detection body portion facing the second portion in a second region of the moving range. A combined facing length of the first and second detection body portions relative to the first and second portions is maintained constant over the moving range. Induced voltages generated in the first and second portions vary in accordance with positions of the respective detection body portions, thereby enabling detection of an absolute position of the shaft relative to the fixed member. A distance between center positions of the first and second detection body portions in the axial direction is less than one-half of the moving range.

### CROSS-REFERENCE TO RELATED APPLICATIONS

The present patent application claims the priority of Japanese patent application No. 2025-063368 filed on Apr. 7, 2025 and the priority of Japanese patent application No. 2025-274660 filed on Dec. 22, 2025, the entire contents of which are incorporated herein by reference.

### TECHNICAL FIELD

The present invention relates to a position detection device for detecting the position of a shaft that moves forward and backward in an axial direction within a predetermined range of motion relative to a fixed member.

### BACKGROUND TECHNOLOGY

Conventionally, position detection devices for detecting the position of a shaft that moves forward and backward in the axial direction are used, for example, to detect the position of a rack shaft in a vehicle steering device. The applicant of the present invention has proposed such a position detection device as described in Patent Literatures 1 and 2.

Each of the position detection devices described in Patent Literatures 1 and 2 has a detection body (target) provided on a rack shaft, a substrate disposed opposite the rack shaft, and a processing unit that calculates the position of the rack shaft. The substrate includes an excitation coil that generates an alternating current magnetic field, and a sine wave detection coil and a cosine wave detection coil whose magnetic flux links with the alternating magnetic field generated by the excitation coil, wherein an induced voltage generated in the sine wave detection coil and the cosine wave detection coil changes according to the position of the detection body relative to the substrate. The processing unit calculates the position of the rack shaft based on the induced voltages generated in the sine wave detection coil and the cosine wave detection coil.

In the device of Patent Literature 1, a sine wave detection coil and a cosine wave detection coil, each having the shape of a sine wave and a cosine wave for one cycle (360°), are formed along the longitudinal direction of the substrate. In the device of Patent Literature 2, a first portion and a second portion of a sine wave detection coil having a shape corresponding to a half cycle (180°) of a sine wave are arranged in the short-side direction of the substrate, and a first portion and a second portion of a cosine wave detection coil having a shape corresponding to a half cycle (180°) of a cosine wave are also arranged in the short-side direction of the substrate. Furthermore, in the device of Patent Literature 2, the detection body comprises a first detection body portion and a second detection body portion, wherein the first detection body portion faces the first portion of the sine wave detection coil and the cosine wave detection coil, and the second detection body portion faces the second portion of the sine wave detection coil and the cosine wave detection coil.

### CITATION LIST

Patent Literature 1: JP2024-106418A
Patent Literature 2: JP2024-159397A

### SUMMARY OF THE INVENTION

In the device of Patent Literature 1, the longitudinal length of the detection coils (sine wave detection coil, cosine wave detection coil) is at least equal to the travel distance (stroke length) from one moving end to the other moving end of the rack shaft, resulting in a large substrate on which the detection coils are formed. In the device of Patent Literature 2, the length of the portion of the rack shaft where the detection coils are formed in the axial direction becomes shorter, enabling the substrate to be miniaturized. However, the center-to-center distance between the first detection body portion and the second detection body portion fixed to the rack shaft must be set to half the stroke length of the rack shaft. If the length of a portion of the rack shaft where the detector can be installed is short, it may not be possible to apply the position detection device of Patent Literature 2 to that rack shaft.

Therefore, an object of the present invention is to provide a position detection device that can shorten the length of the portion where the detection coil is formed in the axial direction of the shaft while also shortening the length of the portion required for installing the detection body on the shaft.

For the purpose of solving the above problem, the present invention provides a position detection device for detecting a position of a shaft that moves backward and forward in an axial direction within a predetermined moving range relative to a fixed member, comprising:
a detection coil fixed relative to the fixed member;
a detection body fixed relative to the shaft; and
an excitation coil that generates a magnetic flux interlinking the detection coil and the detection body,
wherein the detection coil includes a first portion and a second portion in which an induced voltage is generated when the magnetic flux interlinks, and a connecting portion connecting the first portion and the second portion,
wherein the first portion and the second portion extend parallel to each other along the axial direction, and at least a portion of the first portion and the second portion is arranged in an arrangement direction perpendicular to their respective extending directions,
wherein the detection body includes a first detection body portion facing the first portion in a portion of the moving range, and a second detection body portion facing the second portion in another portion of the moving range, where a combined length of a facing length of the first detection body portion facing the first portion and a facing length of the second detection body portion facing the second portion is constant throughout an entire moving range,
wherein an induced voltage generated in the first portion varies with a position of the first detection body portion relative to the first portion, and an induced voltage generated in the second portion varies with a position of the second detection body relative to the second portion, thereby enabling detection of an absolute position of the shaft relative to the fixed member, and
wherein a distance in the axial direction between a center position of the first detection body portion and a center position of the second detection body portion is less than one-half of a distance from one end to an other end of the moving range.

### Advantageous Effects of the Invention

According to the present invention, it is possible to provide a position detection device that can shorten the length of the portion where the detection coil is formed in the axial direction of the shaft while also shortening the length of the portion required for installing the detection body on the shaft.

### BRIEF DESCRIPTION OF THE DRAWINGS

FIG. 1 is a schematic diagram of a vehicle equipped with a steer-by-wire steering device with a stroke sensor as a position detection device according to the first embodiment of the present invention.

FIG. 2 is a cross-sectional view of a rack shaft, a housing, a detection target, and a substrate taken along line A-A in FIG. 1.

FIG. 3 is a perspective view of the rack shaft, a housing body, the detection target, and the substrate.

FIG. 4 is a configuration diagram showing the rack shaft and the detection target as viewed from a substrate side.

FIG. 5A is a plan view showing the wiring pattern of a front surface-side wiring layer on the substrate.

FIG. 5B is a plan view showing the wiring pattern of a back surface-side wiring layer on the substrate.

FIG. 5C is a plan view showing the wiring patterns of the front surface-side and back surface-side wiring layers superimposed.

FIG. 6 is a schematic diagram showing the circuit configuration of the substrate.

FIGS. 7A to 7C are explanatory diagrams showing the relative positions between the substrate and first and second detection body portions.

FIG. 8 is a graph showing an example of the relationship between a supply voltage supplied to an excitation coil and an induced voltage induced in a sine wave detection coil and a cosine wave detection coil.

FIG. 9 is an explanatory diagram schematically showing the relationship between a peak voltage, which is a peak value of the induced voltage, induced in the sine wave detection coil, and the positions of the first detection body portion and the second detection body portion.

FIG. 10 is an explanatory diagram schematically showing the relationship between a peak voltage, which is a peak value of the induced voltage, induced in the cosine wave detection coil, and the positions of the first detection body portion and the second detection body portion.

FIGS. 11A to 11D are explanatory diagrams schematically showing the positional relationship between the first detection body portion and the second detection body portion, and the first portion and the second portion of the sine wave detection coil and the cosine wave detection coil, for four patterns where their axial relative positions differ.

FIG. 12 is a schematic diagram showing the circuit configuration of a substrate according to the second embodiment of the present invention.

FIG. 13 is a schematic diagram showing the circuit configuration of a substrate according to the third embodiment of the present invention.

FIG. 14A is a plan view showing the wiring pattern of the front surface-side wiring layer on the substrate.

FIG. 14B is a plan view showing the wiring pattern of the back surface-side wiring layer as viewed from the front surface-side. FIG. 14C is a plan view showing the wiring patterns of the front surface-side and back surface-side wiring layers superimposed.

FIG. 15 is an enlarged view of portions A, B, C, and D in FIG. 14C.

FIGS. 16A and 16B are schematic diagrams showing the circuit configurations of the sine wave detection coil and the cosine wave detection coil on the substrate.

FIGS. 17A and 17B are explanatory diagrams schematically showing the effect of the inclination of the rack shaft on a magnetic flux density intersecting the sine wave detection coil and the cosine wave detection coil.

### DETAILED DESCRIPTION OF THE INVENTION

### First Embodiment

### (Steering Device Configuration)

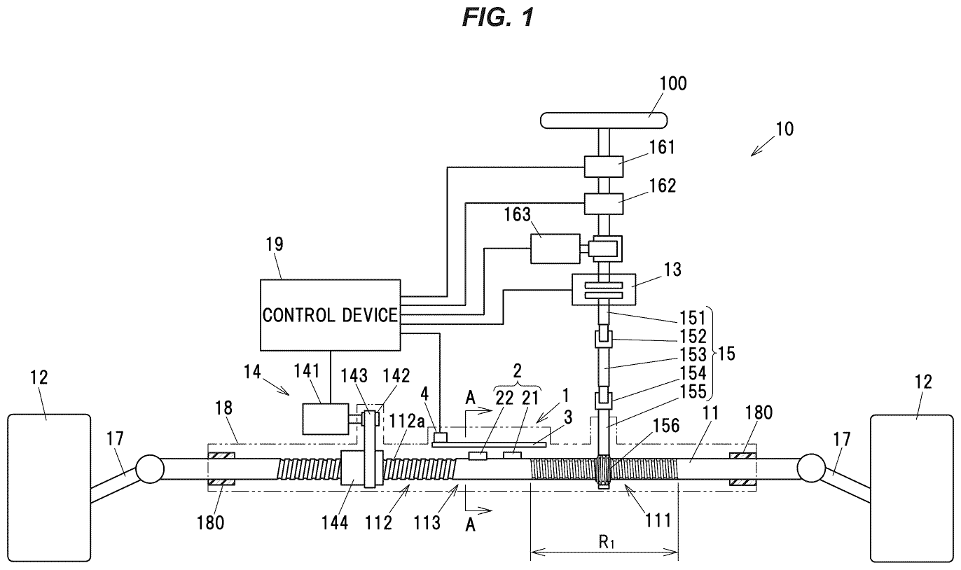

FIG. 1 is a schematic diagram of a vehicle equipped with a steer-by-wire steering device 10 with a stroke sensor 1 as a position detection device according to the first embodiment of the present invention. In this steering device 10, it is possible to switch between a manual driving mode, where the driver steers a steering wheel 100 to move a rack shaft 11 backward and forward, thereby steering front wheels 12 (the left and right steering wheels), and an automatic driving mode, where a connection between the steering wheel 100 and the rack shaft 11 is disconnected by a clutch 13, thereby moving the rack shaft 11 axially backward and forward by an electric-type moving device 14.

Furthermore, the steering device 10 includes a steering shaft 15 that rotates about its central axis in response to the steering rotation of the steering wheel 100 in the manual driving mode, a steering angle sensor 161 that detects the steering angle of the steering wheel 100, a steering torque sensor 162 that detects the steering torque applied to the steering wheel 100, a reaction motor 163 that applies steering reaction force to the steering wheel 100 in the automatic driving mode, a tie rod 17 connecting both ends of the rack shaft 11 to the front wheels 12, a rack housing 18 that accommodates the rack shaft 11, and a control device 19 that controls the clutch 13, the moving device 14, and the reaction motor 163.

The steering shaft 15 includes a column shaft 151 with the steering wheel 100 attached to one end, an intermediate shaft 153 connected to the other end of the column shaft 151 via a joint 152, and a pinion shaft 155 connected to the intermediate shaft 153 via a joint 154. The steering angle sensor 161, the steering torque sensor 162, the reaction motor 163, and the clutch 13 are provided corresponding to the column shaft 151. A pinion teeth portion 156 is provided at the end of the pinion shaft 155.

In FIG. 1, the rack housing 18 is shown with a two-dot line, and the interior of the rack housing 18 is shown with a solid line. The rack shaft 11 is supported for axial movement by rack bushings 180 attached to both ends of the rack housing 18. In the present embodiment, as one example, the moving device 14 is configured by a ball screw mechanism. The moving device 14 includes a steering motor 141, a pulley 142 fixed to a rotation shaft of the steering motor 141, a belt 143 wrapped around the pulley 142, and a ball screw nut 144 that rotates due to the circulating movement of the belt 143. The rack shaft 11 is rotationally fixed relative to the rack housing 18. Rotation of the ball screw nut 144 causes the rack shaft 11 to move axially. In manual operation mode, the moving device 14 functions as a steering assist device that assists the driver's steering operation of the steering wheel 100.

A rack teeth portion 111, which meshes with the pinion teeth portion 156 of the pinion shaft 155, is formed on a portion of the rack shaft 11 in the axial direction. In manual driving mode, rotation of the pinion shaft 155 in response to the rotation of the steering wheel 100 causes the pinion teeth portion 156 of the pinion shaft 155 to mesh with the rack teeth portion 111, thereby moving the rack shaft 11. Another portion in the axial direction of the rack shaft 11 serves as a driving force input portion 112, where the driving force from the moving device 14, which moves the rack shaft 11 axially, is input. A ball screw groove 112a, into which the ball screw nut 144 screws, is spirally formed on an outer peripheral surface of the driving force input portion 112.

The stroke sensor 1 is positioned corresponding to a central portion 113 between the section where the rack teeth portion 111 is formed and the moving force input portion 112 where the ball screw groove 112a is formed, along the axial direction of the rack shaft 11, to detect the position of the rack shaft 11 relative to the rack housing 18, which serves as a fixed member. The rack shaft 11 moves backward and forward in the axial direction (i.e., reciprocates axially) within a predetermined range relative to the rack housing 18. In FIG. 1, this moving range is indicated by R₁. The control device 19 executes various controls based on the detection results from the steering angle sensor 161, the steering torque sensor 162, and the stroke sensor 1, as well as the detection results from other onboard sensors.

### (Stroke Sensor 1 Configuration)

The stroke sensor 1 includes a detection body (detection target) 2 fixed to the central portion 113 of the rack shaft 11, a substrate 3 positioned opposite the rack shaft 11 and the detection body 2, and a circuit portion 4 formed of multiple electronic components mounted on the substrate 3. The substrate 3 is fixed within the rack housing 18, parallel to the rack shaft 11. The stroke sensor 1 detects the position of the rack shaft 11 relative to the rack housing 18 based on the position of the detection body 2 and outputs the detected position information to the control device 19. In the automatic driving mode, the control device 19 controls the steering motor 141 such that the position of the rack shaft 11 detected by the stroke sensor 1 corresponds to the steering angle detected by the steering angle sensor 161.

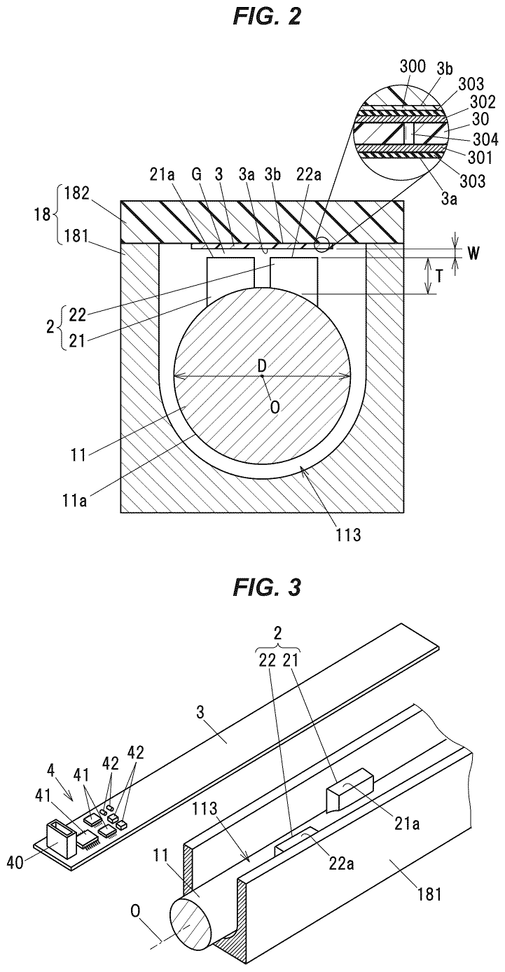

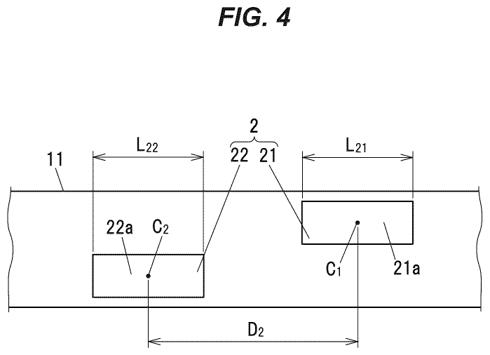

FIG. 2 is a cross-sectional view of the rack shaft 11, the rack housing 18, the detection body 2, and the substrate 3 taken along line A-A in FIG. 1. FIG. 3 is a perspective view showing the rack shaft 11, a main body 181 of the rack housing 18, the detection body 2, and the substrate 3. FIG. 4 is a configuration diagram showing the rack shaft 11 and the detection body 2 as viewed from the substrate 3 side. In FIG. 3, a center axis O of the rack shaft 11 is shown by a dotted line. In the present specification, “the axial direction” refers to the direction parallel to the center axis O of the rack shaft 11.

As shown in FIG. 3, a plurality of active elements 41, such as ICs, and a plurality of passive elements 42, such as resistors and capacitors, are mounted at one end portion in the longitudinal direction of the substrate 3. These active elements 41 and passive elements 42 constitute the circuit portion 4. The circuit portion 4 has a calculating function (i.e., processing function) that calculates the position of the rack shaft 11 based on the output voltage of the detection coils 32, 33 described later. Furthermore, a connector 40 for connecting a cable linking the substrate 3 and the control device 19 is mounted on the substrate 3.

The rack housing 18 includes a main body 181 made of metal for accommodating the rack shaft 11, and a cover body 182 fixed to seal an opening formed in the main body 181. The main body 181 is a non-magnetic material and is made, e.g., of an aluminum alloy formed by die casting. The cover body 182 is a non-magnetic material and is made, for example, of a resin formed by injection molding. The rack shaft 11 is a rod-shaped body made of steel with a circular cross-section.

The detection body 2 is composed of a first detection body portion 21 and a second detection body portion 22. In the present embodiment, the first detection body portion 21 and the second detection body portion 22 are separate bodies. The first detection body portion 21 and the second detection body portion 22 are fixed to the central portion 113 of the rack shaft 11 at positions spaced apart along the axial direction of the rack shaft 11. However, the first detection body portion 21 and the second detection body portion 22 may be formed integrally. When the first detection body portion 21 and the second detection body portion 22 are formed integrally, they are connected by a connecting portion extending along the axial direction of the rack shaft 11.

In the present embodiment, the first detection body portion 21 and the second detection body portion 22 are made of a material having higher conductivity than the rack shaft 11. Examples of such high-conductivity materials include metals mainly composed of aluminum or copper. Alternatively, the first detection body portion 21 and the second detection body portion 22 may be made of a material having a higher permeability than the rack shaft 11. For this high-permeability material, it is desirable to use a magnetic material such as ferrite, which has high electrical resistance and is less prone to eddy current generation.

Furthermore, in the present embodiment, the first detection body portion 21 and the second detection body portion 22 are provided so as to protrude from an outer peripheral surface 11a of the rack shaft 11 toward the substrate 3. Therefore, even if a material having the same permeability as the rack shaft 11 or a material having the same conductivity as the rack shaft 11 is used as the material for the first detection body portion 21 and the second detection body portion 22, the functions and effects described below can be achieved. However, to enhance position detection accuracy, it is desirable to use a highly conductive material with higher conductivity than the rack shaft 11 material, or a highly permeable material with higher permeability than the material of the rack shaft 11, as the material for the first detection body portion 21 and the second detection body portion 22.

The first detection body portion 21 and the second detection body portion 22 are fixed to the upper part of the rack shaft 11 by a fixing means such as bonding or welding. Opposing surfaces 21a and 22a of the first detection body portion 21 and the second detection body portion 22, which face the substrate 3, are formed flat and face a front surface 3a of the substrate 3 in parallel across an air gap G. A back surface 3b of the substrate 3 is fixed to the cover body 182 by adhesive 300. The shape of the facing surfaces 21a and 22a of the first detection body portion 21 and the second detection body portion 22, as viewed from the substrate 3 side, is a long rectangular shape extending in the axial direction of the rack shaft 11.

A width W of the air gap G is, e.g., 1 mm. A minimum thickness T of the first detection body portion 21 and the second detection body portion 22 in the direction perpendicular to the facing surfaces 21a and 22a is, e.g., 5 mm. A diameter D of the rack shaft 11 is, e.g., 25 mm. In the present embodiment, the rack shaft 11 is formed with a circular cross-section. However, the cross-sectional shape of the rack shaft 11 is not limited to a circle; it may also be, for example, D-shaped with a portion formed in a straight line, or polygonal.

The substrate 3 is a two-layer printed circuit board. A front surface-side wiring layer 301 is formed on the front surface 3a-side of a flat base material 30 made of a dielectric such as FR4 (glass fiber impregnated with epoxy resin and thermally cured). A back surface-side wiring layer 302 is formed on the back surface 3b-side of the base material 30. The front surface-side wiring layer 301 and the back surface-side wiring layer 302 are covered by an electrically insulating resist film 303. The wiring patterns of the front surface-side wiring layer 301 and the back surface-side wiring layer 302 are connected by multiple vias 304 that penetrate the base material 30 in its thickness direction. The front surface 3a of the substrate 3 is formed flat and has a rectangular shape elongated in the axial direction of the rack shaft 11. The short-side direction of the substrate 3 is the width direction perpendicular to the axial direction. The substrate 3 may also be a two-layer flexible printed circuit board (FPC) wherein a front surface-side wiring layer is formed on the front surface-side of a sheet-like base material made of a dielectric such as polyimide, and a back surface-side wiring layer is formed on the back surface-side of the base material. The thickness of the substrate 3 is, e.g., 3 mm or less.

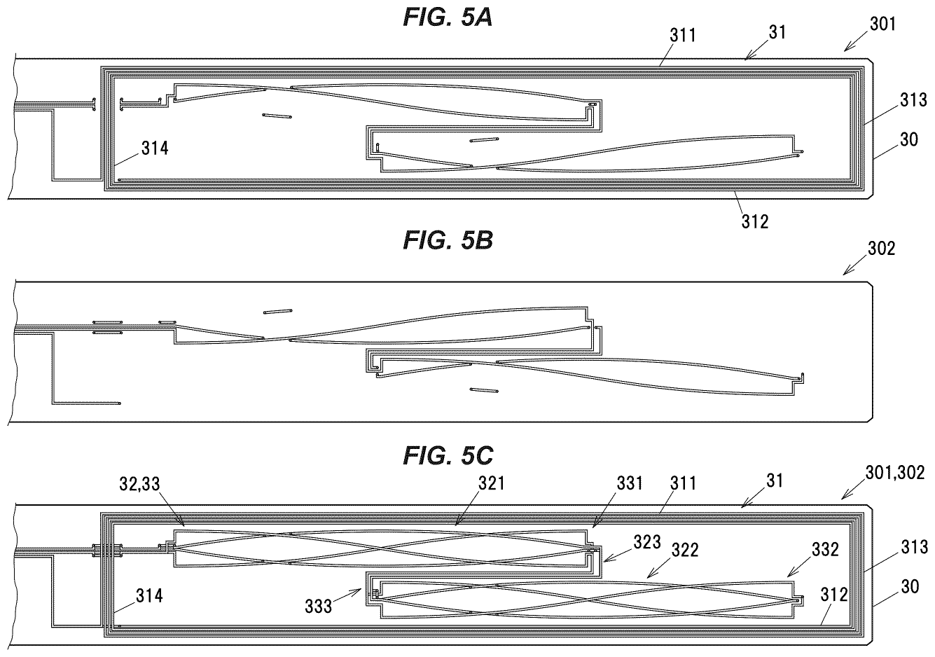

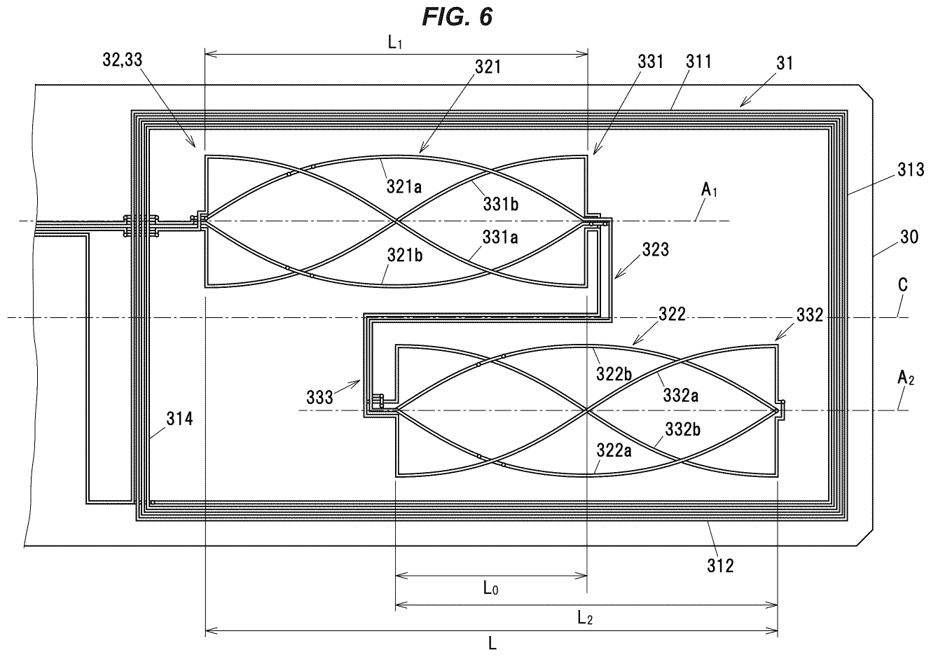

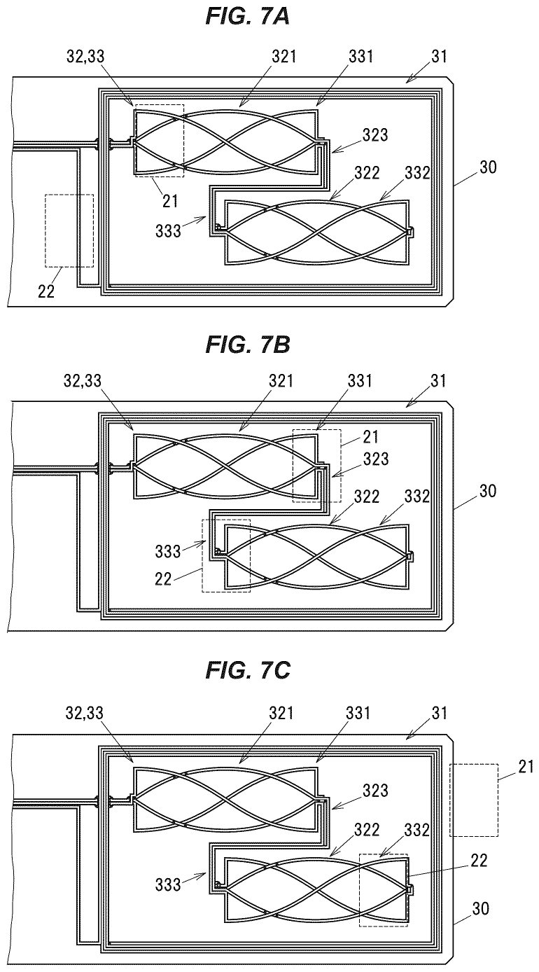

Next, the configuration of the wirings on the substrate 3 will be described in detail with reference to FIGS. 5A to 7C. FIG. 5A is a plan view of the front surface 3a showing the wiring pattern of the front surface-side wiring layer 301 on the substrate 3. FIG. 5B is a plan view of the wiring pattern of the back surface-side wiring layer 302 on the substrate 3 as seen from the front surface 3a-side. FIG. 5C is a plan view showing the wiring patterns of the front-side wiring layer 301 and the back surface-side wiring layer 302 superimposed. FIG. 6 is a schematic diagram showing the circuit configuration of substrate 3. FIGS. 7A to 7C are explanatory drawings showing the relative positional relationship between the substrate 3 and the first detection body portion 21 and second detection body portion 22. Note that the wiring patterns shown in these drawings are merely examples; various forms of wiring patterns can be adopted as long as the substrate 3 is formed to achieve the effects of the present invention.

On the substrate 3, an excitation coil 31 for generating an alternating magnetic field and two detection coils 32, 33, whose magnetic flux links with the alternating magnetic field generated by the excitation coil 31, are formed by the wiring patterns on the front surface-side wiring layer 301 and the back surface-side wiring layer 302 of the substrate 3. The circuit portion 4 supplies a sinusoidal alternating current to the excitation coil 31, causing the excitation coil 31 to generate an alternating magnetic field at a frequency corresponding to the frequency of this alternating current. The excitation coil 31 and the detection coils 32, 33 have their positions fixed relative to the rack housing 18 because the substrate 3 is fixed to the rack housing 18.

The excitation coil 31 has a rectangular shape with a pair of long sides 311, 312 extending in the axial direction of the rack shaft 11, and a pair of short sides 313, 314 between the pair of long sides 311, 312. The two detection coils 32, 33 are formed inside the excitation coil 31 and are stacked in the thickness direction of the substrate 3. The induced voltage is generated in the two detection coils 32, 33 by the alternating magnetic field generated by the excitation coil 31.

The magnetic flux of the alternating magnetic field generated by the excitation coil 31 also links with the first detection body portion 21 and the second detection body portion 22 of the detection body 2. The magnetic flux interlinking the first detection body portion 21 and the second detection body portion 22 affects the intensity distribution of the magnetic flux interlinking the two detection coils 32 and 33. Consequently, the magnitude of the induced voltage generated in the two detection coils 32 and 33 by the alternating magnetic field generated by the excitation coil 31 varies depending on the position of the first detection body portion 21 and the second detection body portion 22. The phase of the voltage induced in each of the detection coils 32 and 33 differs as the rack shaft 11 moves from one moving end to the other moving end along its axial direction. In the present embodiment, the phase of the voltage induced in the detection coils 32 and 33 differs by 90°.

Hereinafter, of the two detection coils 32, 33, one detection coil 32 is referred to as the sine wave detection coil 32, and the other detection coil 33 is referred to as the cosine wave detection coil 33. In FIGS. 6 and 7A to 7C, to clearly show the shapes of the sine wave detection coil 32 and the cosine wave detection coil 33, the width of the substrate 3 in the short-side direction (up-down direction in the drawing) is shown exaggerated compared to the length in the longitudinal direction (left-right direction in the drawing). Furthermore, in FIG. 6, the center line C of the substrate 3 along the longitudinal direction is shown as a dotted line. The center line C is the bisector dividing the portion of the substrate 3 where the sine wave detection coil 32 and cosine wave detection coil 33 are formed into two equal parts in the short-side direction. Hereinafter, the side of the substrate 3 in the longitudinal direction where the circuit portion 4 is provided (left side of the drawing) is referred to as one side of the longitudinal direction, and the opposite side (right side of the drawing) is referred to as the other side of the longitudinal direction.

The sine wave detection coil 32 includes a first portion 321 and a second portion 322, wherein an induced voltage is generated when the magnetic flux of the alternating magnetic field from the excitation coil 31 links through them, and a connecting portion 323 connecting the first portion 321 and the second portion 322. The first portion 321 and the second portion 322 of the sine wave detection coil 32 extend parallel to each other along the axial direction, and a portion of the first portion 321 and a portion of the second portion 322 are arranged in an arrangement direction perpendicular to their respective extension directions (the short-side direction of the substrate 3). In the present embodiment, the first portion 321 and the second portion 322 of the sine wave detection coil 32 are arranged in the arrangement direction over a length equal to one-half of the axial length of the first portion 321 and the second portion 322. The connecting portion 323 connects the end on the other longitudinal side of the first portion 321 to the end on one longitudinal side of the second portion 322.

The cosine wave detection coil 33 includes a first portion 331 and a second portion 332, wherein an induced voltage is generated by the magnetic flux of the alternating magnetic field of the excitation coil 31 interlinking through, and a connecting portion 333 connecting the first portion 331 and the second portion 332. The first portion 331 and the second portion 332 of the cosine wave detection coil 33 extend parallel to each other along the axial direction. Furthermore, a portion of the first portion 331 and a portion of the second portion 332 are arranged in an arrangement direction perpendicular to their respective extension directions (the short-side direction of the substrate 3). In the present embodiment, the first portion 331 and the second portion 332 of the cosine wave detection coil 33 are arranged in the arrangement direction over a length equal to one-half of the axial length of the first portion 331 and the second portion 332. The connecting portion 333 connects the end on the other longitudinal side of the first portion 331 to the end on one longitudinal side of the second portion 332.

In the present embodiment, the axial lengths of the first portion 321 and second portion 322 of the sine wave detection coil 32, and the axial lengths of the first portion 331 and second portion 332 of the cosine wave detection coil 33, are all the same. Furthermore, the first portion 321 of the sine wave detection coil 32 overlaps with the first portion 331 of the cosine wave detection coil 33 in the thickness direction of the substrate 3, and the second portion 322 of the sine wave detection coil 32 overlaps with the second portion 332 of the cosine wave detection coil 33 in the thickness direction of the substrate 3. The connecting portions 323 and 333 extend along the center line C between the first portion 321 and the second portion 322 of the sine wave detection coil 32, and between the first portion 331 and the second portion 332 of the cosine wave detection coil 33.

In FIG. 6, a length L₁ indicates the first portions 321, 331 of the sine wave detection coil 32 and the cosine wave detection coil 33, respectively, in the longitudinal direction of the substrate 3. A length L₂ indicates the second portions 322, 332 of the sine wave detection coil 32 and the cosine wave detection coil 33, respectively. Furthermore, a length L₀ indicates the portion where the first portions 321, 331 and the second portions 322, 332 of the sine wave detection coil 32 and the cosine wave detection coil 33 are arranged in the short-side direction of the substrate 3. L₁ and L₂ are equal, and L₀ is one-half of L₁ and L₂. The length L (L=L₁+L₂−L₀) of the portion where the sine wave detection coil 32 and the cosine wave detection coil 33 are formed in the longitudinal direction of the substrate 3 is shorter than the axial length of the moving range R₁ of the rack shaft 11.

The sine wave detection coil 32 has one end in the longitudinal direction of the first portion 321 connected to the circuit portion 4. The induced voltage generated in the sine wave detection coil 32 is output to the circuit portion 4 as the output voltage of the sine wave detection coil 32. Similarly, the cosine wave detection coil 33 has one end in the longitudinal direction of the first portion 331 connected to the circuit portion 4. The induced voltage generated in the cosine wave detection coil 33 is output to the circuit portion 4 as the output voltage of the cosine wave detection coil 33.

As shown in FIG. 6, the first portion 321 of the sine wave detection coil 32 has a shape combining a pair of conductor lines 321a, 321b that are line-symmetrical about a symmetrical axis A₁ extending in the axial direction. Similarly, the second portion 322 of the sine wave detection coil 32 has a shape formed by combining a pair of conductor lines 322a, 322b that are line-symmetrical about a symmetrical axis A₂ extending in the axial direction. The connecting portion 323 connects the conductor line 321a of the first portion 321 to the conductor line 322a of the second portion 322, and also connects the conductor line 321b of the first portion 321 to the conductor line 322b of the second portion 322. In FIG. 6, the conductor lines 321b, 322b are shown in gray.

In the first portion 321 of the sine wave detection coil 32, one conductor line 321a in the short-side direction of the substrate 3 is positioned farther from the center line C than the other conductor line 321b. Similarly, in the second portion 322, one conductor line 322a connected to one conductor line 321a of the first portion 321 is positioned farther from the center line C than the other conductor line 322b. That is, in the sine wave detection coil 32, the arrangement of the pair of conductor lines 321a, 321b in the first portion 321 and the pair of conductor lines 322a, 322b in the second portion 322 relative to the symmetrical axes A₁ and A₂ is reversed between the first portion 321 and the second portion 322. At the connecting portion 323, to prevent induced voltage from occurring due to the alternating magnetic field generated by the excitation coil 31, wherein the wiring pattern connecting the conductor line 321a of the first portion 321 to the conductor line 322a of the second portion 322 and the wiring pattern connecting the conductor line 321b of the first portion 321 to the conductor line 322b of the second portion 322 overlap in the thickness direction of the substrate 3.

The first portion 331 of the cosine wave detection coil 33 has a shape combining a pair of conductor lines 331a, 331b that are line-symmetrical about the symmetrical axis A₁ extending in the axial direction. Similarly, the second portion 332 of the cosine wave detection coil 33 has a shape formed by combining a pair of conductor lines 332a, 332b that are line-symmetrical about the symmetrical axis A₂ extending in the axial direction. The connecting portion 333 connects the conductor line 331a of the first portion 331 to the conductor line 332a of the second portion 332, and also connects the conductor line 331b of the first portion 331 to the conductor line 332b of the second portion 332. In FIG. 6, the conductor lines 331b, 332b are shown in gray.

In the first portion 331 of the cosine wave detection coil 33, at one longitudinal end, one conductor line 331a is positioned farther from the center line C, while the other conductor line 331b is positioned closer to the center line C. At the other longitudinal end of the first portion 331, the relative positions of the one conductor line 331a and the other conductor line 331b are reversed. Similarly, in the second portion 332, at one longitudinal end, one conductor line 332a is positioned farther from the center line C, while the other conductor line 332b is positioned closer to the center line C. At the other longitudinal end of the second portion 332, the positional relationship between one conductor line 332a and the other conductor line 332b is reversed. That is, in the cosine wave detection coil 33, the arrangement of the pair of conductor lines 331a, 331b in the first portion 331 and the pair of conductor lines 332a, 332b in the second portion 332 relative to the symmetrical axes A₁ and A₂ is reversed between the first portion 331 and the second portion 332. At the connecting portion 333, to prevent induced voltage from occurring due to the alternating magnetic field generated by the excitation coil 31, the wiring pattern connecting the conductor line 331a of the first portion 331 to the conductor line 332a of the second portion 332 and the wiring pattern connecting the conductor line 331b of the first portion 331 to the conductor line 332b of the second portion 332 overlap in the thickness direction of the substrate 3.

The pair of conductor lines 321a, 321b of the first portion 321 and the pair of conductor lines 322a, 322b of the second portion 322 of the sine wave detection coil 32, as well as the pair of conductor lines 331a, 331b of the first portion 331 and the pair of conductor lines 332a, 332b of the second portion 332 of the cosine wave detection coil 33, each have a sinusoidal waveform. More specifically, the shape of one conductor line 321a in the first portion 321 of the sine wave detection coil 32 is a sinusoidal waveform in the range from 0° to 180° when the symmetrical axis A₁ is regarded as the phase axis. The shape of the other conductor line 322a in the second portion 322 is a sinusoidal waveform in the range from 180° to 360° when the symmetrical axis A₂ is regarded as the phase axis. The shape of the other conductor line 321b in the first portion 321 of the sine wave detection coil 32 is a sinusoidal waveform in the range from 180° to 360° when the symmetrical axis A₁ is regarded as the phase axis. The shape of the other conductor line 322b in the second portion 322 is a sinusoidal waveform in the range from 0° to 180° when the symmetrical axis A₂ is regarded as the phase axis.

Furthermore, the shape of one conductor line 331a in the first portion 331 of the cosine wave detection coil 33 is a sinusoidal waveform within the range from 90° to 270° when the symmetrical axis A₁ is regarded as the phase axis. The shape of one conductor line 332a in the second portion 332 is a sinusoidal waveform within the range from 270° to 360° and from 0° to 90° when the symmetrical axis A₂ is regarded as the phase axis. The shape of the other conductor line 331b in the first portion 331 of the cosine wave detection coil 33 is a sinusoidal waveform in the range from 270° to 360° and from 0° to 90° when the symmetrical axis A₁ is regarded as the phase axis. The shape of the other conductor line 332b in the second portion 332 is a sinusoidal waveform in the range from 90° to 270° when the symmetrical axis A₂ is regarded as the phase axis.

Furthermore, the shape of one conductor line 331a in the first portion 331 of the cosine wave detection coil 33 can be described as a cosinusoidal waveform in the range from 0° to 180° when the symmetrical axis A₁ is regarded as the phase axis. Similarly, the shape of one conductor line 332a in the second portion 332 of the cosine wave detection coil 33 can be described as a cosinusoidal waveform in the range from 180° to 360° when the symmetrical axis A₂ is regarded as the phase axis. Furthermore, the shape of the other conductor line 331b in the first portion 331 of the cosine wave detection coil 33 can be described as a cosinusoidal waveform in the range from 180° to 360° when the symmetrical axis A₁ is regarded as the phase axis. The shape of the other conductor line 332b in the second portion 332 of the cosine wave detection coil 33 can be described as a cosinusoidal waveform in the range from 0° to 180° when the symmetrical axis A₂ is regarded as the phase axis.

FIG. 7A shows the relative positional relationship between the substrate 3 and the first detection body portion 21 and the second detection body portion 22 when the rack shaft 11 is at one moving end in the axial direction. FIG. 7B shows the relative positional relationship between the substrate 3 and the first detection body portion 21 and the second detection body portion 22 when the rack shaft 11 is at an intermediate position between one moving end and the other moving end in the axial direction (i.e., when the steering wheel 100 is in the neutral position). FIG. 7C shows the relative positional relationship between the substrate 3 and the first detection body portion 21 and the second detection body portion 22 when the rack shaft 11 is at the other moving end in the axial direction. In FIGS. 7A to 7C, the first detection body portion 21 and the second detection body portion 22 are shown with dashed lines.

As to the detection body 2, when the rack shaft 11 moves along the moving range R₁ shown in FIG. 1 from one axial moving end to the other axial moving end, the first detection body portion 21 faces the first portions 321, 331 of the sine wave detection coil 32 and the cosine wave detection coil 33, respectively, while the second detection body portion 22 faces the second portions 322, 332 of the sine wave detection coil 32 and the cosine wave detection coil 33, respectively. The first detection body portion 21 faces the first portions 321, 331 of the sine wave detection coil 32 and the cosine wave detection coil 33 in part of the moving range R₁, while the second detection body portion 22 faces the second portions 322, 332 of the sine wave detection coil 32 and the cosine wave detection coil 33 in another portion of the moving range R₁.

Within the moving range R₁ of the rack shaft 11, the range where the first detection body portion 21 faces the first portions 321, 331 of the sine wave detection coil 32 and the cosine wave detection coil 33, and the range where the second detection body portion 22 faces the second portions 322, 332 of the sine wave detection coil 32 and the cosine wave detection coil 33, are offset in the axial direction of the rack shaft 11. The total length, which is the sum of the facing length where the first detection body portion 21 faces the first portions 321, 331 of the sine wave detection coil 32 and the cosine wave detection coil 33, and the facing length where the second detection body portion 22 faces the second portions 322, 332 of the sine wave detection coil 32 and the cosine wave detection coil 33, is constant throughout the entire range of movement R₁.

The induced voltage generated in the first portions 321, 331 of the sine wave detection coil 32 and the cosine wave detection coil 33 varies depending on the position of the first detection body portion 21 relative to the first portions 321, 331. The induced voltage generated in the second portions 322, 332 of the sine wave detection coil 32 and the cosine wave detection coil 33 changes depending on the position of the second detection body portion 22 relative to the second portions 322, 332. The circuit portion 4 detects the absolute position of the rack shaft 11 relative to the rack housing 18 based on the induced voltage that changes depending on the position of the first detection body portion 21 relative to the first portions 321, 331 of the sine wave detection coil 32 and the cosine wave detection coil 33, and the induced voltage that changes depending on the position of the second detection body portion 22 relative to the second portions 322, 332 of the sine wave detection coil 32 and the cosine wave detection coil 33. The specific calculation method for determining the absolute position of the rack shaft 11 will be described later.

FIG. 4 shows a center position C₁ of the first detection body portion 21 and a center position C₂ of the second detection body portion 22 along the axial direction of the rack shaft 11, as well as a distance D₂ between the center positions C₁ and C₂ along the axial direction of the rack shaft 11. The center position C₁ is the position of the center point of a facing surface 21a of the first detection body portion 21 relative to the substrate 3. The center position C₂ is the position of the center point of a facing surface 22a of the second detection body portion 22 relative to the substrate 3. When the distance from one end to the other end of the moving range R₁ of the rack shaft 11 is defined as D₁, D₂ is less than one-half of D₁. In the present embodiment, D₂ is 30% or less of D₁, and a length L₂₁ of the first detection body portion 21 and a length L₂₂ of the second detection body portion 22 in the axial direction of the rack shaft 11 are 20% or less of the distance D₁.

When the first detection body portion 21 and the second detection body portion 22 are made of a material with higher conductivity than the rack shaft 11, the density of the magnetic flux interlinking to the sine wave detection coil 32 and the cosine wave detection coil 33 decreases due to the eddy currents generated in the first detection body portion 21 and the second detection body portion 22 by the alternating magnetic field. Consequently, the magnetic flux density in the portion of the substrate 3 facing the first detection body portion 21 and the second detection body portion 22 becomes lower than in other portions. Furthermore, when the first detection body portion 21 and the second detection body portion 22 are made of a material with higher permeability than the rack shaft 11, magnetic flux concentrates and flows through the first detection body portion 21 and the second detection body portion 22. Consequently, the magnetic flux density in the portion of the substrate 3 facing the first detection body portion 21 and the second detection body portion 22 becomes higher than in other portions. Therefore, the magnitude of the voltage induced in the sine wave detection coil 32 and the cosine wave detection coil 33 varies depending on the position of the first detection body portion 21 and the second detection body portion 22 relative to the substrate 3.

In the sine wave detection coil 32 and the cosine wave detection coil 33, voltages having the same cycle as the alternating current supplied from the circuit portion 4 to the excitation coil 31 are induced. The peak values of the induced voltages vary depending on the position of the first detection body portion 21 and the second detection body portion 22. Here, the peak value of the voltage refers to the maximum absolute value of the voltage within one cycle of the alternating current supplied to the excitation coil 31.

The peak values of the voltages induced in the sine wave detection coil 32 and the cosine wave detection coil 33 change within a range less than one cycle as the rack shaft 11 moves from one moving end to the other moving end in the axial direction. This enables the stroke sensor 1 to detect the absolute position of the rack shaft 11 over the entire range of axial movement R₁ of the rack shaft 11.

### (Operation of Stroke Sensor 1)

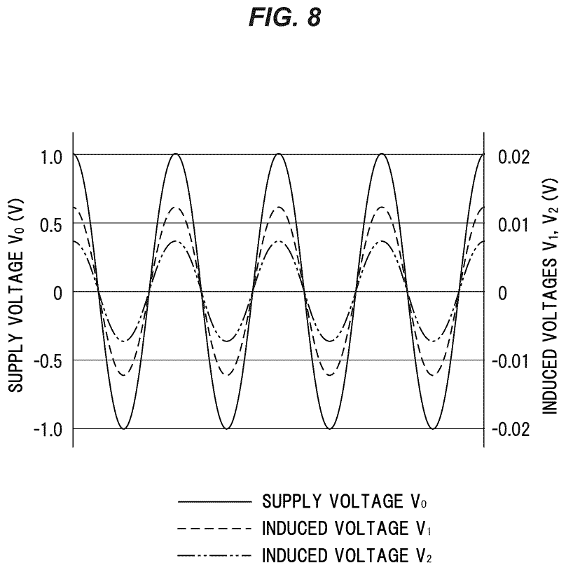

Next, the operation of the stroke sensor 1 for detecting the position of the detection body 2 relative to the substrate 3 will be described with reference to FIGS. 8 to 10. In the following description, the position of the detection body 2 refers to the position of the midpoint between the first detection body portion 21 and the second detection body portion 22 along the axial direction of the rack shaft 11.

FIG. 8 shows a graph showing an example of the relationship between the supply voltage V₀ supplied from the circuit portion 4 to the excitation coil 31 and the induced voltage V₁ induced in the sine wave detection coil 32 and the induced voltage V₂ induced in the cosine wave detection coil 33 when the first detection body portion 21 overlaps with the first portions 321, 331 of the sine wave detection coil 32 and the cosine wave detection coil 33, respectively. The horizontal axis of the graph in FIG. 8 is the time axis, and the left and right vertical axes show the relationship between the supply voltage V₀ and the induced voltage V₁ induced in the sine wave detection coil 32 and the induced voltage V₂ induced in the cosine wave detection coil 33. The horizontal axis of the graph in FIG. 8 is the time axis, and the left and right vertical axes show the supply voltage V₀ and the induced voltages V₁ and V₂, respectively.

In the example shown in FIG. 8, the supply voltage V₀ and the induced voltages V₁, V₂ are in phase. However, when the second detection body portion 22 overlaps with the second portions 322, 332 of the sine wave detection coil 32 and the cosine wave detection coil 33, respectively, the induced voltage V₁ induced in the sine wave detection coil 32 becomes out of phase with the supply voltage V₀ supplied to the excitation coil 31. Furthermore, the induced voltage V₂ induced in the cosine wave detection coil 33 alternates between in-phase and out-of-phase each time the first detection body portion 21 or the second detection body portion 22 passes through the position where one conductor lines 331a, 332a cross the other conductor lines 331b, 332b. An alternating voltage at a high frequency of, e.g., approximately 1 MHz to 1 GHz is supplied to the excitation coil 31 as the supply voltage V₀.

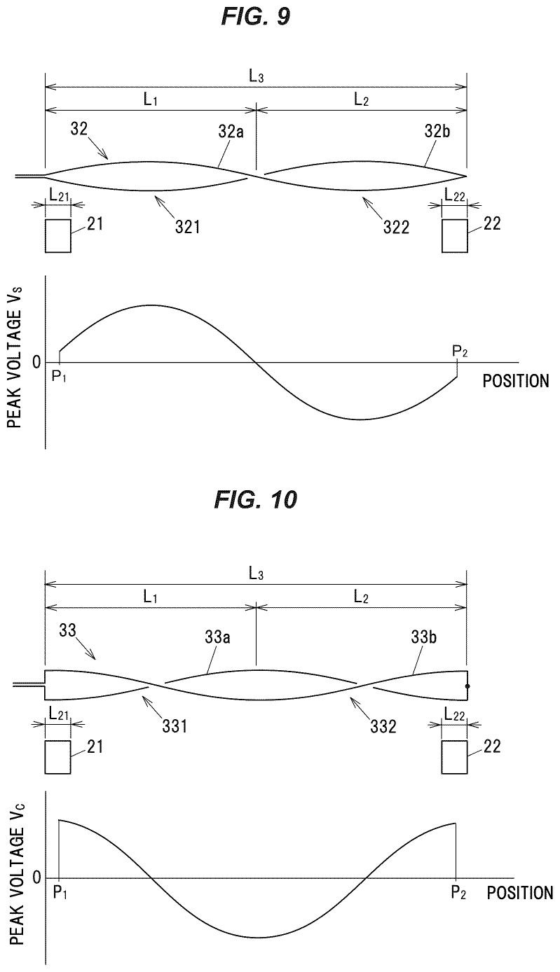

FIG. 9 is an explanatory diagram schematically showing the relationship between the peak voltage Vs, which is the peak value of the induced voltage V₁ induced in the sine wave detection coil 32, and the positions of the first detection body portion 21 and the second detection body portion 22. FIG. 10 is an explanatory diagram schematically showing the relationship between the peak voltage Vc, which is the peak value of the induced voltage V₂ induced in the cosine wave detection coil 33, and the positions of the first detection body portion 21 and the second detection body portion 22. In the graphs of peak voltages Vs and Vc shown in FIGS. 9 and 10, the horizontal axis indicates the position of the detection body 2. Furthermore, in FIGS. 9 and 10, the connecting portions 323, 333 are omitted, and the first portions 321, 331 and the second portions 322, 332 are arranged side by side in the left-right direction of the drawings.

The stroke sensor 1 can detect the absolute position of the detection body 2 within a range where the total length, obtained adding the facing length of the first detection body portion 21 facing the first portion 321, 331 of the sine wave detection coil 32 and the cosine wave detection coil 33 and the facing length of the second detection body portion 22 facing the second portion 322, 332 of the sine wave detection coil 32 and the cosine wave detection coil 33, is constant. In the graphs shown in FIGS. 9 and 10, the horizontal axis coordinate of the detection body 2 when the rack shaft 11 is at one moving end in the axial direction is denoted as P₁, and the horizontal axis coordinate of the detection body 2 when the rack shaft 11 is at the other moving end in the axial direction is denoted as P₂. The peak voltages Vs and Vc at each position are shown.

Furthermore, in the graphs shown in FIGS. 9 and 10, the peak voltage Vs of the sine wave detection coil 32 is positive when the induced voltage V₁ induced in the sine wave detection coil 32 is in phase with the supply voltage V₀ supplied to the excitation coil 31, and negative when it is out of phase. Similarly, the peak voltage Vc of the cosine wave detection coil 33 is considered positive when the induced voltage V₂ induced in the cosine wave detection coil 33 is in phase with the supply voltage V₀ supplied to the excitation coil 31, and negative when it is out of phase.

Here, defining ox as in equation [1], the peak voltages Vs and Vc are obtained by setting the position of the detection body 2 (i.e., the position of the rack shaft 11) as Xp when the positions of one longitudinal ends of the sine wave detection coil 32 and the cosine wave detection coil 33 (the positions on the vertical axis in the graphs shown in FIGS. 9 and 10) are set to 0 (mm), using equations [2] and [3], respectively. In equation [1], L₃ is the total length of L₁ (length of the first portions 321, 331) and L₂ (length of the second portions 322, 332), namely, (L₃=L₁+L₂). In equations [2] and [3], A is a predetermined constant.

$${ω}_{x} = \frac{2 π}{{L}_{3}} \qquad [ 1 ]$$

$$Vs = Asin ( {ω}_{x} {X}_{P} ) \qquad [ 2 ]$$

$$Vc = Acos ( {ω}_{x} {X}_{p} ) \qquad [ 3 ]$$

From Equations [2] and [3], the coordinate value Xp of the detection body 2 on the horizontal axis of the graphs shown in FIGS. 9 and 10 is obtained by Equation [4]. That is, the circuit portion 4 can calculate the position of the detection body 2 based on the peak voltages Vs and Vc.

$$( Vs ≧ 0 ) {X}_{p} = \frac{a tan 2 ( Vs , Vc )}{{ω}_{x}} \qquad [ 4 ]$$

$$( Vs < 0 ) {X}_{p} = \frac{a tan 2 ( Vs , Vc ) + 2 π}{{ω}_{x}}$$

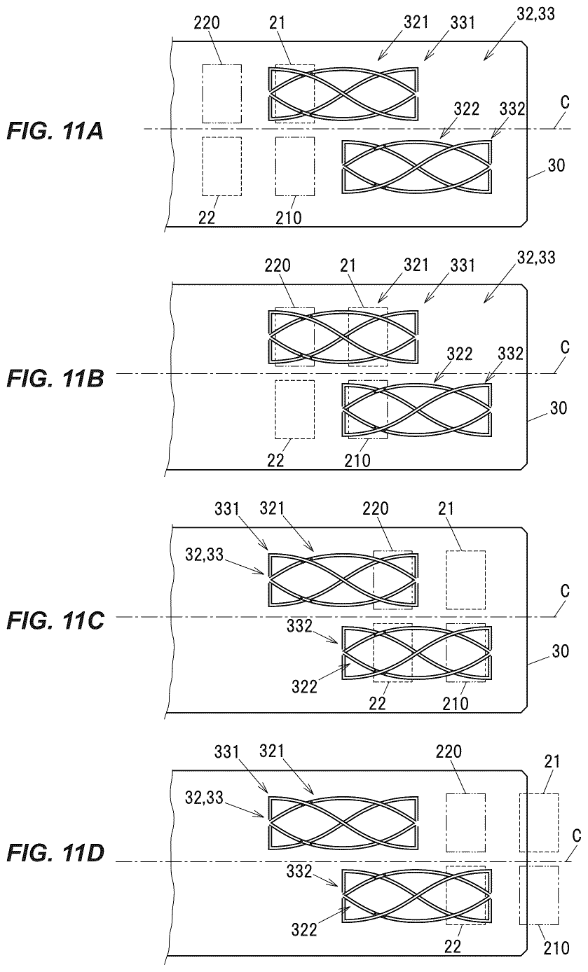

Furthermore, in the present embodiment, the influence exerted by the first detection body portion 21 on the magnetic fields of the second portions 322, 332 of the sine wave detection coil 32 and the cosine wave detection coil 33 and the influence exerted by the second detection body portion 22 on the magnetic fields of the first portions 321, 331 of the sine wave detection coil 32 and the cosine wave detection coil 33 cancel each other out. This suppresses detection errors in the position of the detection body 2 caused by these influences. This is explained in more detail with reference to FIGS. 11A to 11D.

FIGS. 11A to 11D are explanatory diagrams schematically showing the positional relationship between the first detection body portion 21 and the second detection body portion 22, and the first portion 321, 331 and the second portion 322, 332 of the sine wave detection coil 32 and the cosine wave detection coil 33, for four patterns where their axial relative positions differ. In FIGS. 11A to 11D, the positions of the first detection body portion 21 and the second detection body portion 22 are shown with dashed lines. A first detection body portion projection portion 210, which is line-symmetrical with respect to the center line C of the substrate 3 relative to the first detection body portion 21, is shown with a double dotted line. A second detection body portion projection portion 220, which is line-symmetrical with respect to the center line C of the substrate 3 relative to the second detection body portion 22, is shown with a double dotted line. Furthermore, the first detection body portion projection portion 210 and the second detection body portion projection portion 220 are shaded with a light gray.

The first detection body portion 21 affects the magnetic field strength at the first portions 321, 331 of the sine wave detection coil 32 and the cosine wave detection coil 33, but this influence also extends to the second portions 322, 332 of the sine wave detection coil 32 and the cosine wave detection coil 33, which are aligned in the short-side direction of the substrate 3 near the first portions 321, 331. Furthermore, the second detection body portion 22 affects the magnetic field strength in the second portions 322, 332 of the sine wave detection coil 32 and the cosine wave detection coil 33, this influence also extends to the first portions 321, 331 of the sine wave detection coil 32 and the cosine wave detection coil 33, which are aligned in the short-side direction of the substrate 3 near the second portions 322, 332. That is, the magnetic field strength decreases in regions overlapping with the first detection body portion projection portion 210 and the second detection body portion projection portion 220.

In the state shown in FIGS. 11B and 11C, the first detection body portion projection portion 210 overlaps the second portions 322, 332 of the sine wave detection coil 32 and the cosine wave detection coil 33, while the second detection body portion projection portion 220 overlaps with the first portions 321, 331 of the sine wave detection coil 32 and the cosine wave detection coil 33. The influence of the first detection body portion projection portion 210 on the induced voltage of the sine wave detection coil 32 and the cosine wave detection coil 33 and the influence of the second detection body portion projection portion 220 on the induced voltage of the sine wave detection coil 32 and the cosine wave detection coil 33 cancel each other out. Consequently, position detection errors caused by these influences are less likely to occur.

Furthermore, in the states shown in FIGS. 11A and 11D, since the first detection body portion projection portion 210 and the second detection body portion projection portion 220 do not overlap with the sine wave detection coil 32 and the cosine wave detection coil 33, the first detection body portion projection portion 210 and the second detection body portion projection portion 220 do not affect the induced voltages of the sine wave detection coil 32 and the cosine wave detection coil 33.

### Effect of the First Embodiment

According to the first embodiment described above, since portions of the first portion 321 and second portion 322 of the sine wave detection coil 32, and portions of the first portion 331 and second portion 332 of the cosine wave detection coil 33, are arranged in the short-side direction of the substrate 3, compared to when the first portions 321, 331 and the second portions 322, 332 are arranged in the longitudinal direction of the substrate 3, the length (L shown in FIG. 6) of the portions forming the sine wave detection coil 32 and the cosine wave detection coil 33 in the axial direction of the rack shaft 11 can be shortened, thereby enabling miniaturization of the substrate 3.

Furthermore, since the distance between the center position C₁ of the first detection body portion 21 and the center position C₂ of the second detection body portion 22 in the axial direction of the rack shaft 11 is less than half the moving range R₁ from one end to the other end of the rack shaft 11, it is possible to shorten the length of the portion required to provide the detection body 2 on the rack shaft 11.

Furthermore, according to the present embodiment, the influence of the first detection body portion projection portion 210 on the induced voltage of the sine wave detection coil 32 and the cosine wave detection coil 33, and the influence of the second detection body portion projection portion 220 on the induced voltage of the sine wave detection coil 32 and the cosine wave detection coil 33 cancel each other out. Consequently, the detection error of the position of the rack shaft 11 is suppressed. Thus, in the present embodiment, it is possible to achieve a detection error in the position of the rack shaft 11 of, e.g., 0.02% FS or less.

### Second Embodiment

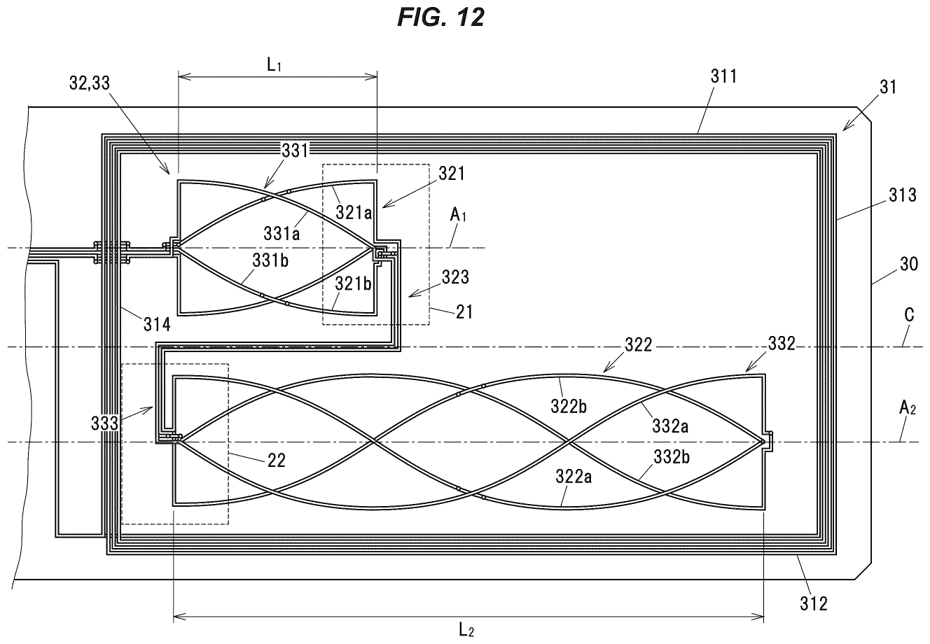

FIG. 12 is a schematic diagram showing the circuit configuration of the substrate 3 according to the second embodiment of the present invention. In FIG. 12, components corresponding to those described with reference to FIG. 6, etc., for the first embodiment are designated by the same reference numerals as in FIG. 6, etc., and redundant descriptions are omitted.

The first embodiment described the case where the axial lengths of the first portions 321, 331 of the sine wave detection coil 32 and the cosine wave detection coil 33 are equal to the axial lengths of the second portions 322, 332 of the sine wave detection coil 32 and the cosine wave detection coil 33. In the second embodiment, the axial lengths of the first portions 321, 331 of the sine wave detection coil 32 and the cosine wave detection coil 33 are shorter than the axial lengths of the second portions 322, 332 of the sine wave detection coil 32 and the cosine wave detection coil 33. In the second embodiment, as shown in FIG. 12, the axial length of the first portion 321, 331 of the sine wave detection coil 32 and the cosine wave detection coil 33 is denoted as L₁, and the axial length of the second portion 322, 332 is denoted as L₂. L₁ is one-third the length of L₂.

In the second embodiment, the entire first portions 321, 331 of the sine wave detection coil 32 and the cosine wave detection coil 33 in the axial direction are arranged in the short-side direction of the substrate 3 alongside the second portions 322, 332, and the positions of one longitudinal ends of the first portions 321, 331 in the longitudinal direction of the substrate 3 and the positions of one longitudinal ends of the second portions 322, 332 in the longitudinal direction of the substrate 3 are the same. The axial length L₂ of the second portion 322, 332 in the second embodiment is the same as the length L of the portion where the sine wave detection coil 32 and the cosine wave detection coil 33 are formed in the first embodiment (see FIG. 6).

Furthermore, in the second embodiment, the pair of conductor lines 321a, 321b in the first portion 321 of the sine wave detection coil 32 and the pair of conductor lines 331a, 331b in the first portion 331 of the cosine wave detection coil 33 form a 90° segment of a sine curve when the symmetrical axis A₁ is regarded as the phase axis. Furthermore, the pair of conductor lines 322a, 322b in the second portion 322 of the sine wave detection coil 32 and the pair of conductor lines 332a, 332b in the second portion 332 of the cosine wave detection coil 33 form a 270° segment of a sine curve when the symmetrical axis A₂ is regarded as the phase axis.

In FIG. 12, the first detection body portion 21 and the second detection body portion 22 of the detection body 2 are shown with dashed lines. The respective sizes of the first detection body portion 21 and the second detection body portion 22, and the distance between the center position of the first detection body portion 21 and the center position of the second detection body portion 22 in the axial direction of the rack shaft 11, are the same as in the first embodiment.

The second embodiment also enables the miniaturization of the substrate 3 and the reduction of the length of the portion of the rack shaft 11 required to accommodate the detector 2, similarly to the first embodiment.

### Third Embodiment

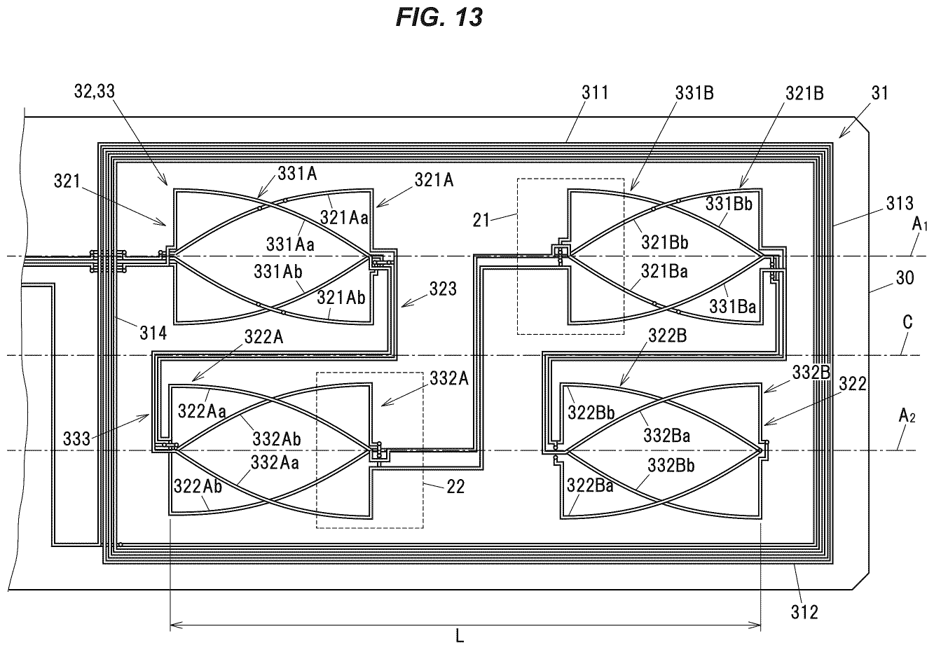

FIG. 13 is a schematic diagram showing the circuit configuration of the substrate 3 according to the third embodiment of the present invention. In FIG. 13, for components corresponding to those described with reference to FIG. 6, etc., for the first embodiment, the same reference numerals as those used in FIG. 6, etc., are used, and redundant descriptions are omitted.

In the third embodiment, the first portion 321 of the sine wave detection coil 32 is divided into a first side first portion 321A on one side in the axial direction and a second side first portion 321B on the other side in the axial direction. The second portion 322 of the sine wave detection coil 32 is divided into a first side second portion 322A on one side in the axial direction and a second side second portion 322B on the other side in the axial direction. The first side first portion 321A and the second side first portion 321B as well as the first side second portion 322A and the second side second portion 322B are arranged at predetermined intervals along the longitudinal direction of the substrate 3. The first side first portion 321A and the first side second portion 322A and the second side first portion 321B and the second side second portion 322B are each arranged in the arrangement direction along the short-side direction of the substrate 3.

A pair of conductor lines 321Aa, 321Ab of the first side first portion 321A, a pair of conductor lines 321Ba, 321Bb of the second side first portion 321B, the pair of conductor lines 322Aa, 322Ab of the first side second portion 322A, and the pair of conductor lines 322Ba, 322Bb of the second side second portion 322B are sinusoidal curves covering 90° when the symmetrical axis A₁ is considered as the phase axis.

Furthermore, in the third embodiment, the first portion 331 of the cosine wave detection coil 33 is divided into a first side first portion 331A in the axial direction and a second side first portion 331B on the other side in the axial direction. The second portion 332 of the cosine wave detection coil 33 is divided into a first side second portion 332A on one side in the axial direction and a second side second portion 332B on the other side in the axial direction. The first side first portion 331A and the second side first portion 331B as well as the first side second portion 332A and the second side second portion 332B are arranged at predetermined intervals along the longitudinal direction of the substrate 3. The first side first portion 331A and the first side second portion 332A, and the second side first portion 331B and the second side second portion 332B are each arranged in the arrangement direction along the short-side direction of the substrate 3.

A pair of conductor lines 331Aa, 331Ab of the first side first portion 331A, a pair of conductor lines 331Ba, 331Bb of the second side first portion 331B, a pair of conductor lines 332Aa, 332Ab of the first side second portion 332A, and the pair of conductor lines 332Ba, 332Bb of the second side second portion 332B are sinusoidal curves covering 90 degrees when the symmetrical axis A₁ is considered as the phase axis.

The connecting portion 323 of the sine wave detection coil 32 connects the conductor lines 321Aa, 322Aa, 321Ba, 322Ba, and also connects the conductor lines 321Ab, 322Ab, 321Bb, 322Bb. The connecting portion 333 of the cosine wave detection coil 33 connects the conductor lines 331Aa, 332Aa, 331Ba, 332Ba, and also connects the conductor lines 331Ab, 332Ab, 331Bb, 332Bb.

In FIG. 13, the first detection body portion 21 and the second detection body portion 22 of the detection body 2 are shown with dashed lines. The respective sizes of the first detection body portion 21 and the second detection body portion 22, and the distance between the center position of the first detection body portion 21 and the center position of the second detection body portion 22 in the axial direction of the rack shaft 11, are the same as in the first embodiment. Furthermore, the length L of the portion where the sine wave detection coil 32 and the cosine wave detection coil 33 are formed in the third embodiment is the same as the same length L in the first embodiment (see FIG. 6).

The third embodiment also enables the miniaturization of the substrate 3 and the shortening of the length of the portion required to install the detection body 2 on the rack shaft 11, similarly to the first embodiment.

### Fourth Embodiment

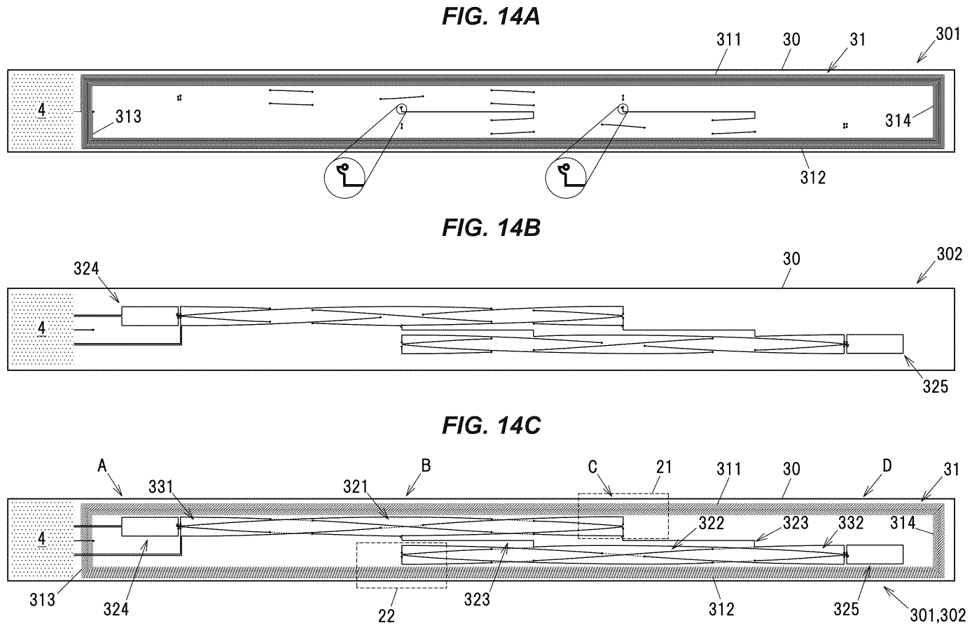

Next, the fourth embodiment of the present invention will be described with reference to FIGS. 14A to 17B. In the fourth embodiment, the sine wave detection coil 32 includes, in addition to the first portion 321 and the second portion 322, adjustment portions 324, 325 that suppress the effect of the inclination of the rack shaft 11 relative to the first portion 321 and the second portion 322 on the induced voltage generated in the first portion 321 and the second portion 322. In the present embodiment, the substrate 3 is also a two-layer substrate, similarly to the first embodiment, wherein the front surface-side wiring layer 301 is formed on the front surface 3a side of the flat base material 30 made of a dielectric such as FR4, and a back surface-side wiring layer 302 is formed on the back surface 3b side of the base material 30.

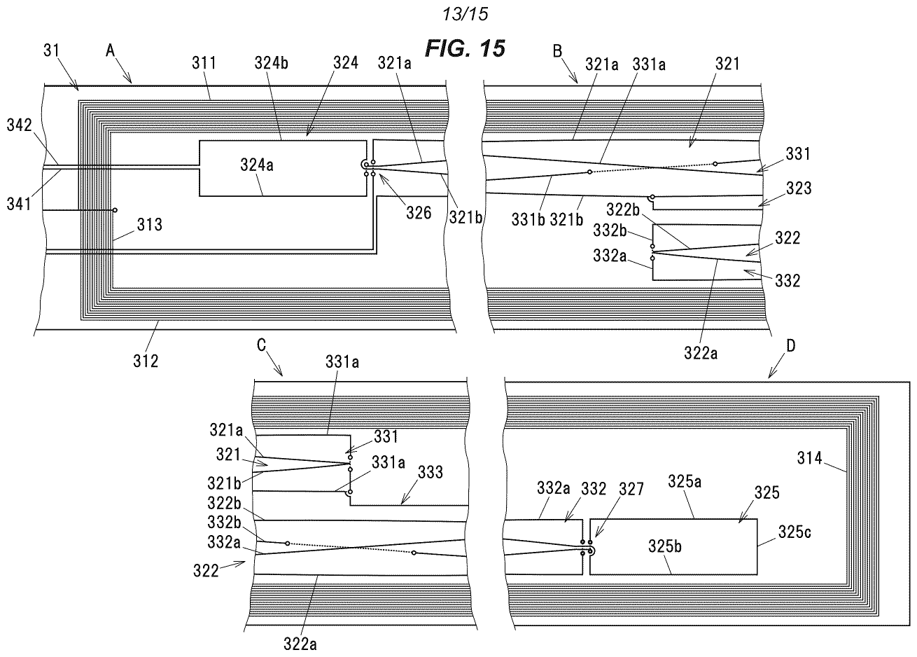

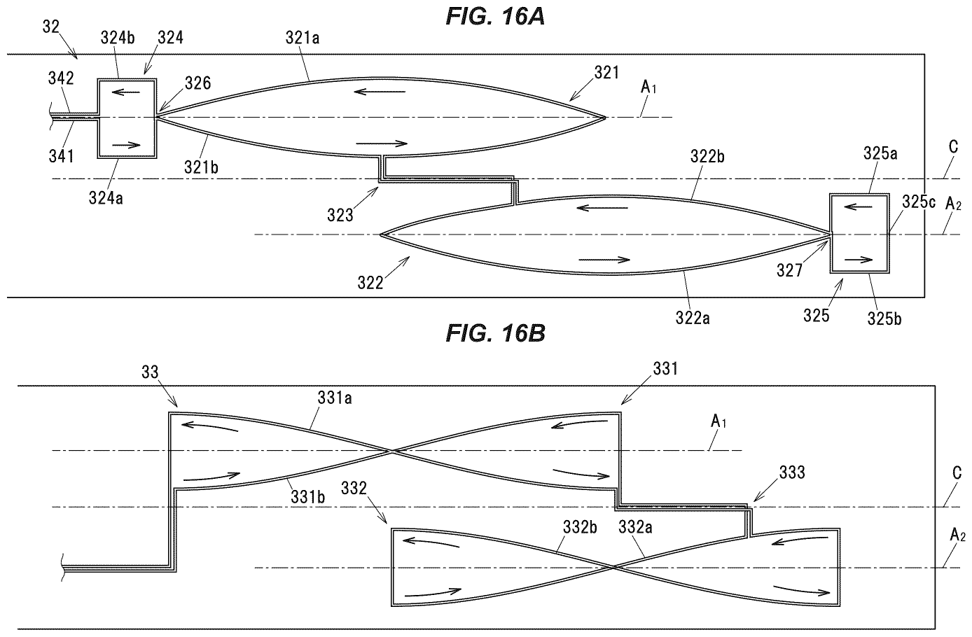

FIG. 14A is a plan view of a front surface 3a showing the wiring pattern of surface-side wiring layer 301 on substrate 3. FIG. 14B is a plan view of the wiring pattern of the back surface-side wiring layer 302 in substrate 3, as seen from the front surface 3a. FIG. 14C is a plan view of substrate 3 showing the wiring pattern of the front surface-side wiring layer 301 superimposed on the wiring pattern of the back surface-side wiring layer 302. FIG. 15 is an enlarged view showing enlarged portions A, B, C, and D in FIG. 14C. FIG. 16A is a schematic diagram showing the circuit configuration of the sine wave detection coil 32 on substrate 3. FIG. 16B is a schematic diagram showing the circuit configuration of the cosine wave detection coil 33 on substrate 3. For components corresponding to those described for the first embodiment in FIGS. 14A to 16B, the same reference numerals as those used in FIGS. 2 to 7C are used, and redundant descriptions are omitted.

In FIGS. 14A, 14B, and 14C, the circuit portion 4 is shown with a gray hatch pattern, omitting detailed depictions of electronic components and circuit patterns within the circuit portion 4. In FIG. 14C and FIG. 15, the wiring patterns on the front surface-side wiring layer 301 are shown in a light color. In FIGS. 16A and 16B, to clearly show the shapes of the sine wave detection coil 32 and the cosine wave detection coil 33, the width of the substrate 3 in the short-side direction (top-bottom direction of the drawing) is exaggerated compared to the length in the longitudinal direction (left-right direction of the drawing). Additionally, the excitation coil 31 is omitted from the illustration. Furthermore, in FIGS. 16A and 16B, multiple arrows indicate the direction of current generated in respective parts of the sine wave detection coil 32 and the cosine wave detection coil 33 due to changes in magnetic field strength as the magnetic field strength gradually increases from the near side to the far side of the drawing.

In the present embodiment, as in the first embodiment, the axial lengths of the first portion 321 and second portion 322 of the sine wave detection coil 32, and the axial lengths of the first portion 331 and second portion 332 of the cosine wave detection coil 33, are all the same. Furthermore, the first portions 321, 331 of the sine wave detection coil 32 and the cosine wave detection coil 33 are offset in one axial direction relative to the second portions 322, 332, respectively. The second portions 322, 332 of the sine wave detection coil 32 and the cosine wave detection coil 33 are offset in the other axial direction relative to the first portions 321, 331. The first portions 321, 331 and the second portions 322, 332 are arranged in the short-side direction of the substrate 3 over a length equal to one-half of the axial length of the first portions 321, 331 and the second portions 322, 332.

Furthermore, in the present embodiment, similarly to the first embodiment, the total length comprising the facing length of the first detection body portion 21 facing the first portions 321, 331 of the sine wave detection coil 32 and the cosine wave detection coil 33, and the facing length of the second detection body portion 22 facing the second portions 322, 332 of the sine wave detection coil 32 and the cosine wave detection coil 33, is constant throughout the entire moving range R₁ and the induced voltage generated in the first portions 321, 331 and second portions 322, 332 enables detection of the absolute position of the rack shaft 11.

In the first embodiment, the case where the connecting portion 323 of the sine wave detection coil 32 connects the other longitudinal end of the first portion 321 to one longitudinal end of the second portion 322, and the connecting portion 333 of the cosine wave detection coil 33 connects the other longitudinal end of the first portion 331 to one longitudinal end of the second portion 332 is explained. However, in the present embodiment, the connecting portion 323 of the sine wave detection coil 32 connects the longitudinal center portion of the conductor line 321b of the first portion 321 to a portion of the conductor line 322b of the second portion 322, while the connecting portion 333 of the cosine wave detection coil 33 connects the longitudinal other end of the first portion 331 to a portion of the conductor line 322a of the second portion 332.

The adjustment portions 324, 325 are each rectangular in shape with a long dimension in the longitudinal direction of the substrate 3 and are provided corresponding to the first portion 321 and the second portion 322 of the sine wave detection coil 32, respectively. Hereinafter, the adjustment portion 324 provided corresponding to the first portion 321 of the sine wave detection coil 32 is referred to as a first adjustment portion 324, and the adjustment portion 325 provided corresponding to the second portion 322 is referred to as a second adjustment portion 325. The first adjustment portion 324 is continuous with one longitudinal end of the first portion 321 and is arranged axially adjacent to the first portion 321. The second adjustment portion 325 is continuous with the other longitudinal end of the second portion 322 and is arranged in the axial direction parallel to the second portion 322. That is, the first and second adjustment portions 324, 325 are provided at both axial ends of the sine wave detection coil 32.

The first adjustment portion 324 is composed of a pair of first adjustment portion conductor lines 324a, 324b, which are connected to the first portion 321 of the sine wave detection coil 32 at a connection point 326. Of the pair of first adjustment portion conductor lines 324a, 324b, one first adjustment portion conductor line 324a is connected at the connection point 326 to one conductor line 321a of the first portion 321 of the sine wave detection coil 32, and the other first adjustment portion conductor line 324b is connected at the connection point 326 to the other conductor line 321b of the first portion 321 of the sine wave detection coil 32. One first adjustment portion conductor line 324a is provided on the opposite side of one conductor line 321a relative to the symmetrical axis A₁, and the other first adjustment portion conductor line 324b is provided on the opposite side of the other conductor line 321b relative to the symmetrical axis A₁. That is, the conductor formed by connecting one first adjustment portion conductor line 324a to one conductor line 321a crosses the conductor formed by connecting the other first adjustment portion conductor line 324b to the other conductor line 321b at connection point 326. Thus, the first adjustment portion 324 functions to cancel out part of the induced voltage generated in the first portion 321 due to changes in the magnetic field perpendicular to the substrate 3. The ends of the first adjustment portion conductor lines 324a, 324b on one longitudinal side are connected to the circuit portion 4 via connection lines 341, 342.

The second adjustment portion 325 is composed of a pair of second adjustment portion conductor lines 325a, 325b, which are connected to the first portion 321 of the sine wave detection coil 32 at a connection point 327. Of the pair of second adjustment portion conductor lines 325a and 325b, one second adjustment portion conductor line 325a is connected at the connection point 327 to one conductor line 322a of the second portion 322 of the sine wave detection coil 32, and the other second adjustment portion conductor line 325b is connected at the connection point 327 to the other conductor line 322b of the second portion 322 of the sine wave detection coil 32. One second adjustment portion conductor line 325a is provided on the opposite side of one conductor line 322a relative to the symmetrical axis A₂, and the other second adjustment portion conductor line 325b is provided on the opposite side of the other conductor line 322b relative to the symmetrical axis A₂. That is, the conductor formed by connecting one second adjustment portion conductor line 325a to one conductor line 322a crosses the conductor formed by connecting the other second adjustment portion conductor line 325b to the other conductor line 322b at connection point 327. Thus, the second adjustment portion 325 functions to cancel a portion of the induced voltage generated in the second portion 322 due to changes in the magnetic field perpendicular to the substrate 3. The ends of the second adjustment portion conductor lines 325a, 325b on the other longitudinal side are connected at a connection point 325c on the symmetrical axis A₂.

For example, if the rack shaft 11 tilts relative to the substrate 3 due to vibration during vehicle operation, causing the spacing between the substrate 3 and the rack shaft 11 to change, the degree to which the rack shaft 11 affects the magnetic flux intensity distribution inside the excitation coil 31 varies depending on the position along the longitudinal direction of the substrate 3. In the present embodiment, the influence of the tilt of the rack shaft 11 on the detection accuracy of the position of the detection body 2 is suppressed by the first adjustment portion 324 and the second adjustment portion 325. Next, the functions and effects of the first adjustment portion 324 and the second adjustment portion 325 will be described.

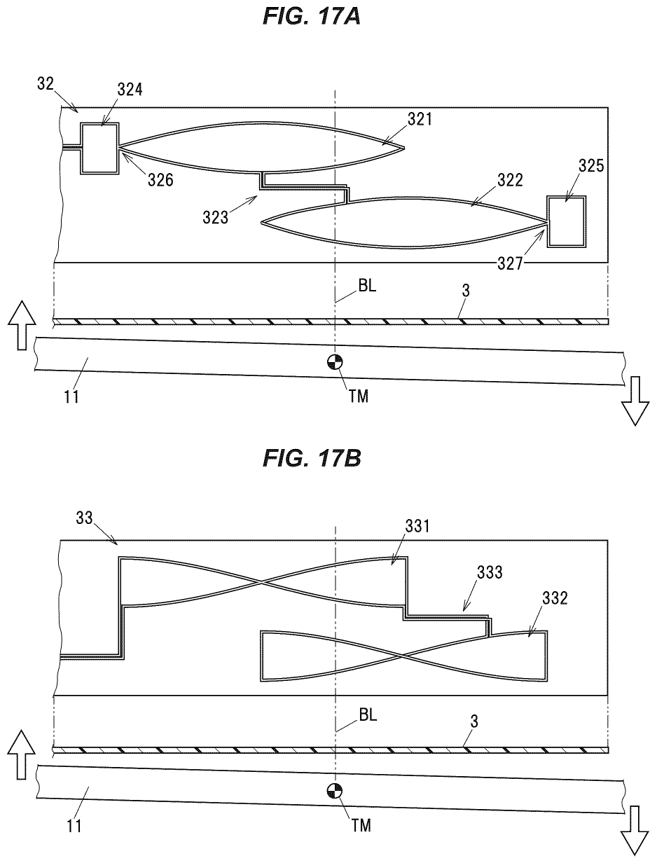

FIG. 17A is an explanatory diagram schematically showing the relationship between the inclination of the rack shaft 11 relative to the substrate 3 and the effect of this inclination on the magnetic flux density interlinking the sine wave detection coil 32. FIG. 17B is an explanatory diagram schematically showing the relationship between the inclination of the rack shaft 11 relative to the substrate 3 and the effect of this inclination on the magnetic flux density interlinking the cosine wave detection coil 33. In FIGS. 17A and 17B, the bisector line BL of the sine wave detection coil 32 and the cosine wave detection coil 33 is shown as a two-point dashed line. The state shown depicts the rack shaft 11 tilted in the vertical direction of the drawing, centered on the point indicated by the target mark TM on this bisector line BL. The rack shaft 11 is tilted such that the portion to the left of the target mark TM in the drawing approaches the substrate 3, while the portion to the right of the target mark TM in the drawing moves away from the substrate 3. Note that the tilt of the rack shaft 11 is exaggerated in FIGS. 17A and 17B.

Eddy currents flow in the rack shaft 11 due to the magnetic flux generated by the excitation coil 31 interlinking therewith. These eddy currents act to weaken the magnetic flux interlinking with the sine wave detection coil 32 and the cosine wave detection coil 33. The effect of this action is greater in regions where the distance between rack shaft 11 and substrate 3 is shorter. In the present embodiment, as described above, since the first portion 321 of the sine wave detection coil 32 is offset to one axial side relative to the second portion 322, when the rack shaft 11 tilts as shown in FIG. 17A, the distance between the first portion 321 and the first adjustment portion 324 of the sine wave detection coil 32 and the rack shaft 11 becomes smaller, while the distance between the second portion 322 and the second adjustment portion 325 of the sine wave detection coil 32 and the rack shaft 11 becomes larger. Furthermore, since the first adjustment portion 324 and the second adjustment portion 325 are provided at both ends of the sine wave detection coil 32, the gap between the first adjustment portion 324 and the rack shaft 11 becomes narrower than the gap between the first portion 321 and the rack shaft 11, and the distance between the second adjustment portion 325 and the rack shaft 11 becomes wider than the distance between the second portion 322 and the rack shaft 11.

According to this configuration of the sine wave detection coil 32, as shown in FIG. 17A, when the rack shaft 11 tilts, the induced voltage of the sine wave detection coil 32 changes due to the change in the induced voltage caused by the magnetic flux density decreasing in the first portion 321 of the sine wave detection coil 32 and increasing in the second portion 322, and the change in the induced voltage of the sine wave detection coil 32 due to the magnetic flux density decreasing in the first adjustment portion 324 and increasing in the second adjustment portion 325 cancel each other out. This enhances the detection accuracy of the position of the detection body 2, i.e., the detection accuracy of the position of the rack shaft 11.

Furthermore, since the distance from the bisector line BL is longer for the first adjustment portion 324 and the second adjustment portion 325 than for the first portion 321 and the second portion 322, the effect of changes in magnetic flux density due to the rack shaft 11 tilting relative to the substrate 3 is greater at the first adjustment portion 324 and the second adjustment portion 325 than at the first portion 321 and the second portion 322. Therefore, for example, as shown in FIGS. 14A to 16B, when the width of the first adjustment portion 324 is equal to the width of the first portion 321 and the width of the second adjustment portion 325 is equal to the width of the second portion 322 in the short-side direction of the substrate 3, even if the lengths of the first adjustment portion 324 and the second adjustment portion 325 in the longitudinal direction of the substrate 3 are shorter than the lengths of the first portion 321 and the second portion 322, the change in the induced voltage of the sine wave detection coil 32 caused by the change in magnetic flux density in the first portion 321 and the second portion 322 can be offset by the change in the induced voltage of the sine wave detection coil 32 caused by the change in magnetic flux density in the first adjustment portion 324 and the second adjustment portion 325.

Furthermore, regarding the cosine wave detection coil 33, due to its configuration, as shown in FIG. 17B, changes in the induced voltage are suppressed even if the rack shaft 11 is tilted relative to the substrate 3. This is because the change in the induced voltage of the cosine wave detection coil 33 due to a change in the magnetic flux density in the first portion 331 of the cosine wave detection coil 33 is mutually offset by the change in the induced voltage of the cosine wave detection coil 33 due to a change in the magnetic flux density in the second portion 332 of the cosine wave detection coil 33.

This fourth embodiment also enables, like the first embodiment, the miniaturization of the substrate 3 and the reduction of the length of the portion required to install the detection body 2 on the rack shaft 11. Furthermore, according to the fourth embodiment, even if the rack shaft 11 is tilted relative to the substrate 3, a decrease in the detection accuracy of the position of the rack shaft 11 can be suppressed.

### SUMMARY OF EMBODIMENTS

Next, the technical concept understood from the above-described embodiments is described using reference numerals from the embodiments. However, the reference numerals in the following description do not limit the components in the claims to the specific parts shown in the embodiments.

According to the first feature, a position detection device (stroke sensor 1) for detecting the position of a shaft (rack shaft 11) that moves backward and forward in an axial direction within a predetermined moving range (R₁) relative to a fixed member (rack housing 18), includes a detection coil 32, 33 fixed relative to the fixed member 18; a detection body 2 fixed relative to the shaft 11; and an excitation coil 31 that generates a magnetic flux interlinking the detection coil 32, 33 and the detection body 2, wherein the detection coil 32, 33 includes a first portion 321, 331 and a second portion 322, 332 in which an induced voltage is generated when the magnetic flux interlinks, and a connecting portion 323, 333 connecting the first portion 321, 331 and the second portion 322, 332, wherein the first portion 321, 331 and the second portion 322, 332 extend parallel to each other along the axial direction, and at least a portion of the first portion 321, 331 and the second portion 322, 332 being arranged in an arrangement direction perpendicular to their respective extending directions, wherein the detection body 2 includes a first detection body portion 21 facing the first portion 321, 331 in a portion of the moving range R₁, and a second detection body portion 22 facing the second portion 322, 332 in another portion of the moving range R₁, where the combined length of the facing length of the first detection body portion 21 facing the first portion 321, 331 and the facing length of the second detection body portion 22 facing the second portion 322, 332 is constant throughout the entire moving range R₁, and the induced voltage generated in the first portion 321, 331 varies with the position of the first detection body portion 22 relative to the first portion 321, 331, and the induced voltage generated in the second portion 322, 332 varies with the position of the second detection body portion 22 relative to the second portion 322, 332, thereby enabling detection of the absolute position of the shaft 11 relative to the fixed member 18, and wherein a distance D₂ in the axial direction between a center position C₁ of the first detection body portion 21 and a center position C₂ of the second detection body portion 22 is less than one-half of a distance from one end to the other end of the moving range R₁.

According to the second feature, in the position detection device 1 as described by the first feature, the lengths of the first portion 321, 331 and the second portion 322, 332 in the axial direction are equal, wherein the first portion 321, 331 and the second portion 322, 332 are arranged in the arrangement direction over a length equal to one-half of the lengths of the first portion 321, 331 and the second portion 322, 332 in the axial direction.

According to the third feature, in the position detection device 1 as described by the first feature, the length of the first portion 321, 331 in the axial direction is shorter than the length of the second portion 322, 332, and the entire first portion 321, 331 is aligned with the second portion 322, 332 in the arrangement direction.

According to the fourth feature, in the position detection device 1 as described by the first feature, the first portion 321, 331 is divided into a first side first portion 321A, 331A on one side in the axial direction and a second side first portion 321B, 331B on the other side in the axial direction, and the second portion 322, 332 is divided into a first side second portion 322A, 332A on one side in the axial direction and a second side second portion 322B, 332B on the other side in the axial direction, wherein the first side first portion 321A, 331A and the first side second portion 322A, 332A are arranged in the arrangement direction, and the second side first portion 321B, 331B and the second side second portion 322B, 332B are arranged in the arrangement direction.

According to the fifth feature, in the position detection device 1 as described by the first feature, the detection coil 32 has an adjustment portion 324, 325 that suppresses the effect of the inclination of the shaft 11 relative to the first portion 321 and the second portion 322 on the induced voltages generated in the first portion 321 and the second portion 322.

According to the sixth feature, in the position detection device 1 as described by the first feature, the detection coil 32 has the first portion 321 offset on one side of the axial direction relative to the second portion 322, and the second portion 322 offset on the other side of the axial direction relative to the first portion 321, wherein the adjustment portion 324, 325 is provided at both ends of the detection coil 32 in the axial direction.

According to the seventh feature, in the position detection device 1 as described by the first feature, the shaft is a steering rack shaft 11, and the shaft 11 includes a rack teeth portion 111 meshed with a pinion shaft 155 that rotates in response to steering rotation of a steering wheel 100, and a driving force input portion 112 into which the driving force from an electric-type moving device 14 that moves the shaft 11 in the axial direction is input, wherein the first detection body portion 21 and the second detection body portion 22 are fixed between the portion of the shaft 11 in the axial direction where the rack teeth portion 111 is provided and the driving force input portion 112.

The above describes embodiments of the present invention; however, the above embodiments do not limit the invention claimed in the claims. It should also be noted that not all combinations of features described in the embodiments are necessarily essential means for solving the problems of the invention.

1. A position detection device for detecting a position of a shaft that moves backward and forward in an axial direction within a predetermined moving range relative to a fixed member, comprising:
a detection coil fixed relative to the fixed member;
a detection body fixed relative to the shaft; and
an excitation coil that generates a magnetic flux interlinking the detection coil and the detection body,
wherein the detection coil includes a first portion and a second portion in which an induced voltage is generated when the magnetic flux interlinks, and a connecting portion connecting the first portion and the second portion,
wherein the first portion and the second portion extend parallel to each other along the axial direction, and at least a portion of the first portion and the second portion is arranged in an arrangement direction perpendicular to their respective extending directions,
wherein the detection body includes a first detection body portion facing the first portion in a portion of the moving range, and a second detection body portion facing the second portion in another portion of the moving range, where a combined length of a facing length of the first detection body portion facing the first portion and a facing length of the second detection body portion facing the second portion is constant throughout an entire moving range,
wherein an induced voltage generated in the first portion varies with a position of the first detection body portion relative to the first portion, and an induced voltage generated in the second portion varies with a position of the second detection body relative to the second portion, thereby enabling detection of an absolute position of the shaft relative to the fixed member, and
wherein a distance in the axial direction between a center position of the first detection body portion and a center position of the second detection body portion is less than one-half of a distance from one end to an other end of the moving range.

2. The position detection device, according to claim 1, wherein lengths of the first portion and the second portion in the axial direction are equal, wherein the first portion and the second portion are arranged in the arrangement direction over a length equal to one-half of the lengths of the first portion and the second portion in the axial direction.

3. The position detection device, according to claim 1, wherein the length of the first portion in the axial direction is shorter than the length of the second portion in the axial direction, and an entire of the first portion is aligned with the second portion in the arrangement direction.

4. The position detection device, according to claim 1, wherein the first portion is divided into a first side first portion on one side in the axial direction and a second side first portion on the other side in the axial direction, and the second portion is divided into a first side second portion on one side in the axial direction and a second side second portion on the other side in the axial direction, wherein the first side first portion and the first side second portion are arranged in the arrangement direction, and the second side first portion and the second side second portion are arranged in the arrangement direction.

5. The position detection device, according to claim 1, wherein the detection coil has an adjustment portion that suppresses an effect of inclination of the shaft relative to the first portion and the second portion on the induced voltages generated in the first portion and the second portion.

6. The position detection device, according to claim 1, wherein the detection coil has the first portion offset on one side of the axial direction relative to the second portion, and the second portion offset on the other side of the axial direction relative to the first portion, wherein the adjustment portion is provided at both ends of the detection coil in the axial direction.

7. The position detection device, according to claim 1, wherein the shaft is a steering rack shaft, wherein the shaft includes a rack teeth portion meshed with a pinion shaft that rotates in response to steering rotation of a steering wheel, and a driving force input portion into which a driving force from an electric-type moving device that moves the shaft in the axial direction is input, wherein the first detection body portion and the second detection body portion are fixed between a portion of the shaft in the axial direction where the rack teeth portion is provided and the driving force input portion.
